(19) United States
(12) Patent Application Publication
(10) Pub. No.: US 2015/0114472 A1
(43) Pub. Date: Apr. 30, 2015

(54) POLYAMIDE COMPOSITES CONTAINING GRAPHENE OXIDE SHEETS

(71) Applicant: The College of William and Mary, Williamsburg, VA (US)

(72) Inventors: David E. Kranbuehl, Williamsburg, VA (US); Hannes C. Schniepp, Williamsburg, VA (US)

(21) Appl. No.: 14/521,849

(22) Filed: Oct. 23, 2014

Related U.S. Application Data
(60) Provisional application No. 61/894,995, filed on Oct. 24, 2013.

(51) Int. Cl. C08K 3/20; F16L 58/00; F17D 1/14; F16L 11/08

(52) U.S. Cl. CPC C08K 3/20; F16L 11/083; F16L 58/00; F17D 1/14
USPC 137/1; 524/424; 428/36.9

(57) ABSTRACT

Graphene oxide/polyamide compositions are provided, as are methods for making and using the compositions. The graphene oxide component of the compositions has a C:O ratio of between 3 and 20, and comprises 0.01% to 5.0% by weight of the composition. Typical polyamide components include specialty nylons such as PA-11 and PA-12. The compositions have reduced water absorption and enhanced durability relative to otherwise identical polyamide compositions lacking the graphene oxide component. The compositions are particularly useful, for example, in flexible pipes and tubes used for transporting oil and gas.

### CROSS-REFERENCE TO RELATED APPLICATIONS

This application claims priority to U.S. Provisional Application 61/894,995 filed on Oct. 24, 2013, and the complete contents are herein incorporated by reference.

### BACKGROUND OF THE INVENTION

Polymer nanocomposite materials have been the subject of research in recent years because of their potential for advanced properties and multi-functionality. Composites using graphene are of particular interest for a wide range of applications, as graphene combines outstanding mechanical, electrical, and barrier properties with a high surface area (see Geim, A. K., and Novoselov, K. S., “The rise of graphene.,” Nature Materials, March 2007, Vol. 6, pp. 183-191). However, the fabrication of macroscopic amounts of single-layer graphene sheets many micrometers in size for large-scale application in nanocomposite materials is challenging, and incorporating such graphene sheets into polymers such that they are well-dispersed is also challenging.

Functionalized graphene sheets, called graphene oxide (GO), with epoxide and hydroxyl groups attached to the carbon backbone, can be dispersed in solvents, including water and other polar solvents, as single sheets. GO can be dispersed in a number of polymers by use of a common solvent, or can be dispersed during polymerization. Hence, GO can be more easily and homogeneously incorporated into polymers than graphene. However, GO does not share the same mechanical, thermal, and conductivity properties as graphene.

Unlike graphene, the properties of GO are tunable based on the C:O ratio. As the C:O ratio is changed from approximately two to approximately twenty, the GO becomes increasingly hydrophobic, and its intermolecular interactions with polymers in any polymer composites are impacted. By tuning the G:O ratio in GO/polymer composites, compositions with particularly advantageous properties can be created.

Polyamides (nylons) are widely used in many applications, and polyamide polymers composed of long hydrocarbon chain repeat units, such as PA-11 (the polymer of 11-aminoundecanoic acid, available from, for example, ATOFINA Chemicals Inc. as RILSAN® polyamide 11) and PA-12 (the polymer of laurolactam, available from, for example, Evonik Industries as Vestamid® polyamide 12), are particularly important in the petroleum industry for the transport of crude oil, gasoline, and natural gas, for example, in flexible pipes for offshore crude oil transport and in automotive fuel lines.

These engineering plastics are widely selected when consistent, long-lasting performance in a range of use conditions is important, such as flexible piping in offshore oil and gas applications. For example, compared to nylon-6, PA-11 has superior aging resistance, mechanical strength, and resistance to creep and fatigue. In particular, its significantly lower water absorption results in better aging resistance, higher chemical resistance, and less property fluctuation due to plasticization by water. Clearly, shutting down an offshore drilling platform to replace aged flexible pipe is a costly proposition, not only due to the cost of labor and the new pipe, but because oil is not pumped in the meantime. Accordingly, aging resistance is very important in the flexible pipe components used in these applications. The correlation between aging and water absorption makes it desirable to produce polyamide polymers having reduced water absorption. Water hydrolysis is also accelerated in the presence of acids, and thus it would be advantageous to have polyamide polymers with increased resistance to acids, either inorganic or organic acids. Note that a reduced rate of hydrolysis allows the materials to be used at a higher continuous operating temperature without sacrificing durability. Furthermore, enhanced chemical resistance would also be advantageous, particularly resistance to injection fluids such as methanol (cite “RILSAN® Polyamide 11 in Oil and Gas: Off-shore Fluids Compatibility Guide”, (2003) Atofina Chemicals Inc.). Additionally, any polyamide composites should maintain compatibility with additives used in offshore exploration and production operations, including for example demulsifiers, corrosion inhibitors, bactericides, paraffin inhibitors, scale inhibitors, and oxygen scavengers.

United States Patent Application 20120068122 describes the introduction of graphene oxide into various polymers to produce composites, followed by reduction of the graphene oxide to produce a modified graphene oxide with a high C:O ratio that has properties more closely resembling those of graphene. However, this reference does not teach improvements in the properties of polyamides.

It would be advantageous to improve the hydrolysis, tensile, and barrier properties of polyamides, particularly specialty polyamides for which durability and consistency of performance under harsh environmental conditions are of paramount importance.

### BRIEF SUMMARY OF THE INVENTION

The invention provides GO/polymer composites with enhanced durability. The composites are formed by combining highly oxidized, and hence relatively hydrophilic, graphene oxide (e.g. GO(2)) with suitable monomers or pre-polymerized polymers in a solvent, and polymerizing the monomers or further polymerizing the pre-polymerized polymers in the presence of the graphene oxide. During polymerization, the oxidation level of the GO component of the mixture is simultaneously reduced, increasing the hydophobicity of the GO component of the composite in the final GO/polymer composite. While the initial relatively high hydrophlicity of the GO facilitates reactivity, the subsequent increase in hydrophobicity is likely responsible, at least in part, for the enhanced durability of the composites: they advantageously exhibit decreased rates of water uptake compared to polymer composites lacking in a GO component, and are thus less susceptible to degradation.

In some embodiments, the new compositions are GO/polyamide composites comprising polyamide with graphene oxide that has a C:O ratio in the range 3-20. In certain embodiments, the polyamide component is either PA-11 or PA-12. These novel GO/polyamide compositions have improved durability. Without being bound by theory, it is believed that the improved durability is primarily attributable to reduced absorption of water, small organic molecules, and acids. Extruded and molded articles made from these novel GO/polyamide compositions are also provided.

The invention also provides methods to improve resistance to hydrolysis in specialty polyamides, methods to inhibit water absorption by specialty polyamides, methods to inhibit chemical absorption by specialty polyamides, and methods to inhibit absorption of acids by specialty polyamides.

Also provided are methods to produce GO/polyamide composites having selected C:O ratios within the graphene oxide component of the composite. For example, in one embodiment, such compositions are produced by extruding low molecular weight PA-11 in the presence of heat and graphene oxide having a low C:O ratio, referred to herein as “GO(L)”. GO(L) refers to graphene oxide having a C:O ratio of L, where L is less than 3. The nomenclature for the various forms of GO is discussed in detail in the definitions provided below. Upon heating, the graphene oxide having a low C:O ratio [i.e., GO(L)] is converted into graphene oxide having a higher C:O ratio of between e.g. 3 and 20, also referred to as GO(m), where m=ranges from 3 to about 20, inclusive of 3 and 20.

The invention also provides methods to transport oil comprising pumping oil through flexible pipes comprising the GO(m)/polyamide composites described herein.

The reactants required to produce the GO(m)/polyamide composite compositions of the present invention can be produced in multiple ways. In one embodiment, GO particles having a C:O ratio of approximately two (2) are created using Staudenmaier's method (see Schniepp et al., “Functionalized single graphene sheets derived from splitting graphite oxide,” The journal of physical chemistry. B, (2006), Vol. 110, pp. 8535-8539) and are then dispersed into a stable water dispersion of single sheets (exfoliated) using ultrasonic techniques. Many polyamides can be synthesized in water from their monomers by heating above the monomer melting point (e.g., to approximately 240° C.) in inert air and removing the water formed during formation of amide bonds.

For example, in one embodiment, the method is carried out by adding the PA-11 monomer to a stable dispersion of GO(2) in water, then heating the mixture at 240° C. in an inert atmosphere, thereby creating GO/PA-11 systems of differing C:O ratios and different molecular weights, depending on the length of time of heating and other experimental variables.

In another embodiment, similar GO/PA-11 composites are prepared from pre-polymerized PA-11 particles of relatively low molecular weight (e.g. in the range of from about 40 to about 60 kD (e.g. about 40, 45, 50, 55 or 60 kD). Heating the pre-polymerized PA-11 particles with GO(2) dispersed in water, at a temperature of 240° C. in an inert atmosphere, creates GO/PA-11 systems with differing thermal histories than those created from monomeric PA-11. Pre-polymerization allows for reduction in the final polymerization time (in the presence of GO), while still achieving polyamide composites with similar molecular weights. By varying reaction parameters, GO/polyamide particle systems with differing C:O ratios (e.g. from 3-20) but similar polymer molecular weights can produced. Some variability in the composition of the final product can also be introduced by starting with GOs having different C:O ratios (e.g. GO ratios other than 2, such as ratios of 3-5), but compatibility issues can limit the range of GO starting materials. In preferred compositions, the end product is a composite having a GO C:O ratio between 3 and 20, formed by a loading of between 0.01% and 5.0% GO by weight.

GO(m)/polyamide compositions of the present invention have significantly reduced water absorption relative to otherwise equivalent polyamide compositions lacking the GO sheets. For example, in some embodiments, a PA-11 composition had approximately 67% more water absorption than an otherwise equivalent polymer composition having 0.1% by weight GO(m), and approximately 175% greater water absorption than an otherwise equivalent polymer composition having about 1.5% by weight GO(m).

The invention provides polymer compositions comprising a polyamide and graphene oxide. The graphene oxide in the compositions has a carbon to oxygen ratio of from 3 to 20. In some aspects, the polyamide is PA-11 or PA-12. In some aspects, the graphene oxide is incorporated at a ratio of from 0.05% to 1.5% by weight of the polymer composition, for example, from 0.05% to 0.5% by weight of the polymer composition. The invention further provides extruded articles and injected molded articles made from the composition. The invention also provides extruded pipes comprising the composition. In the extruded pipes, the graphene oxide is generally incorporated at a ratio of from 0.05% to 1.5% by weight of the polymer composition, and the polyamide may be PA-11 or PA-12.

The invention also provides methods to inhibit hydrolysis in polyamide polymers. The methods comprise a step of incorporating graphene oxide into the polyamide polymers at a weight ratio of between 0.05% and 5.0% graphene oxide by weight, the graphene oxide having a carbon to oxygen ratio of from 3 to 20. The polyamide polymer may be PA-11 or PA-12. In some aspects, the graphene oxide is incorporated at a ratio of from 0.05% to 1.5% by weight of the polymer composition. In other aspects, the graphene oxide is incorporated at a ratio of from 0.05% to 0.5% by weight of the polymer composition.

Further provided are methods to transport a hydrocarbon energy source. The methods include a step of pumping the hydrocarbon energy source through a flexible pipe material which comprises a polymer composition comprising a polyamide and graphene oxide. In the composition, the graphene oxide has a carbon to oxygen ratio of from 3 to 20, and in some aspects, the polyamide is PA-11 or PA-12. For example, the graphene oxide may be incorporated at a ratio of from about 0.05% to about 5.0% by weight of the polymer composition, or at a ratio of from about 0.05% to about 1.5% by weight of the polymer composition.

### BRIEF DESCRIPTION OF THE DRAWINGS

FIG. 1 is a graph showing the diffusion of water into polyamide samples containing various loadings of GO(m) as a function of time. *=neat PA-11; □=PA-11 loaded with 0.1% GO, ⋄=PA-11 loaded with 1% GO; ∘=PA-11 loaded with 1.5% GO.

FIGS. 2A and B show schematic representations of a hose with a layered wall in which at least one layer is made with a composite as describe herein. A, cut-away side view; B, cross-sectional end-on view.

### DETAILED DESCRIPTION OF THE INVENTION

As used herein, each of the following terms has the meaning associated with it as described below.

The term “graphene” refers to a one-atom-thick planar sheet of sp2-bonded carbon atoms that are densely packed in a honeycomb crystal lattice. In one embodiment, it refers to a single-layer version of graphite.

The term “graphene oxide” herein refers to functionalized graphene sheets (FGS)—the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g. approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “m”, where m ranges from 3 to about 20, inclusive. For example, graphene oxide having a C:O ratio of between 3 and 20 is referred to as “GO(3) to GO(20)”, where m ranges from 3 to 20, e.g. m=3, 4, 5, 6, 7, 8, 9, 10, 11, 12, 13, 14, 15, 16, 17, 18, 19 or 20, including all decimal fractions of 0.1 increments in between, e.g. a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g. about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g. “GO(2)” refers to graphene oxide with a C:O ratio of 2.

The phrase “exfoliation of graphene” refers to creating a dispersion of single sheets of GO in which the sheets do not agglomerate.

As used herein “molecular weight” or “MW” (e.g. of polymers) generally refers to the weight average molecular weight.

The term “polyamide” refers to a macromolecule with repeating units linked by amide bonds. Polyamides can be homopolymers (e.g., including but not limited to PA-66, PA-11, or PA-12) or copolymers. Polyamides can be naturally occurring or produced synthetically. Polyamides can also exist as a copolymer having amide bonds along the polymer chain in addition to other chemical bonds linking the monomers of another type of polymer.

In the practice of the present invention, graphene oxide is conveniently produced by the oxidation of graphite by methods known in the art; for example, using the Staudenmaier method, the Hofmann method, the James M Tour method or the Hummers method. These oxidation methods, and methods for their subsequent reduction, have been reviewed by Poh et al. (Poh, H. L., et al., “Graphenes prepared by Staudenmaier, Hofmann, and Hummers methods with consequent thermal exfoliation exhibit very different electrochemical properties”, (2012), Nanoscale, 4, pp. 3515-3522), and are described in: Staudenmaier, L., Verfahren zur darstellung der graphitsaure. Berichte der Deutschen Chemischen Gesellschaft 1898, 31, 1481; Hummers, W. S.; Offeman, R. E., Preparation of Graphitic Oxide. Journal of the American Chemical Society 1958, 80, (6), 1339-1339); U.S. Pat. No. 2,798,878 (Hummers, 1957); and U.S. Pat. No. 8,183,180 (2012, Tour).

GO(L), e.g. GO(2), is used as the starting material in the synthesis of many GO(m)/polyamide composites described herein. Upon sufficient heating, GO(L) in a GO/polyamide composite is converted to GO(m). For example, in one embodiment, adding the PA-11 monomer to a stable dispersion of GO(2) in water, then heating the mixture at 240° C. in an inert atmosphere creates GO/PA-11 systems of differing C:O ratios (e.g. from 3 to about 20) and different molecular weights depending on the length of heating and other experimental variables, with the ratio generally increasing as the time or heating and/or the temperature is increased.

The compositions described herein are generally polyamide composites comprising polyamides and GO(m). Preferred compositions are either GO(m)/PA-11 composites or GO(m)/PA-12 composites having between about 0.01% and about 5.0% (inclusive) GO(m) by weight, including all decimal fractions in between at 0.01 intervals, e.g. about 0.01, 0.02, 0.03, 0.4, 0.05, and so on up to e.g. 4.95, 4.96, 4.97, 4.98, 4.99 and 5.00. Generally, the weight percent of GO to polymer will be from about 0.05 to about 1.5, or from about 0.05 to about 0.5, or from about 0.05 to about 0.25%. Since the GO to polyamide percentage does not change substantially during the GO(L) to GO(m) conversion during processing (e.g. heating), the percentage of GO in the final polyamide composite is little changed from the percentage of GO in the composite prior to the heating step (e.g. about 0.01, 0.02, 0.03, 0.4, 0.05, and so on up to e.g. 4.95, 4.96, 4.97, 4.98, 4.99 and 5.00).

As stated above, the time required to effect the conversion from GO(L) [e.g. GO(2)] to GO(m) in a polyamide composite varies, and is a function of the heating temperature and the local environment to which GO is subjected. The heating temperature is generally above about 30° C., such as above about 40° C., such as above about 60° C., such as above about 80° C., such as above about 100° C., such as above about 140° C., such as above about 180° C., such as above about 200° C., such as above about 250° C., such as above 300° C., such as above about 350° C., such as above about 400° C., and such as above about 450° C. The selection of the heating temperature depends on the materials chosen as the matrix and on the desired level of GO(2) to GO(m) conversion. The time required for sufficient reduction of GO(2) to GO(m) is generally less than or equal to about 4 hours, such as less than or equal to about 2 hours, such as less than or equal to about 1 hour, such as less than or equal to about 30 minutes, such as less than or equal to about 20 minutes, such as less than or equal to about 15 minutes, such as less than or equal to about 10 minutes or less. Alternatively, the time could be longer than 4 hours if low temperatures (e.g. temperatures below about 200° C. (e.g. below about 180, 185, 190, 195, 200, 205, 210, 215 or 220° C.) are used to effect the conversion. The time and temperature of reaction affect the final atomic carbon to oxygen ratio in the graphene oxide; and consequently, in some aspects, the time and temperature are selected to achieve a targeted C:O ratio in the final product. For example, a C:O ratio of about 5.2 may be achieved by a 60 min. reaction at approximately 250° C., and a C:O ratio of about 4.8 may be achieved by a 180 min. reaction at approximately 180° C., etc.

The reduction, i.e. removal of the epoxy, hydroxyl or carboxylic groups containing the GO's oxygen atoms from the surface of the low carbon:oxygen ratio GO(L) to create GO(m), is also influenced by the presence of other molecules which react with the oxygen containing functional groups on GO. Thus, the presence of such molecules can also facilitate reduction. These molecules include amines, alcohols, unsaturated-vinyl molecules and molecules known to induce chemical reduction such as hydrazines. The reactions of epoxy, hydroxyl and carboxyl groups with these molecules are well known.

Reduction, which causes a change (increase) in the C:O ratio can also be induced by exposure to sources of radiant energy other than heat. For example, exposure to UV radiation or to higher frequency radiation induces reduction.

Furthermore, GO(m) can be made from starting graphene oxide materials other than GO(2). Generally, the starting material should be a graphene oxide with high water dispersability, for example, graphene oxide that is sufficiently dispersed to keep the nanoparticles as single sheets.

Heating of the GO-polyamine mixture is carried out by any suitable method known in the art, for example, in a heated incubator, using microwaves, or using various heating elements, etc. In some aspects, heating is applied globally and uniformly to the entire mixture. Alternatively, heating is applied locally, for example, by selective spot treatment with a laser to create at least one localized heated region. Within the mixture, the localized heated region develops a relatively high concentration of reduced GO(m), compared with the non-treated region(s)). As a result, in some embodiments, a patterned conductive element is introduced into the polymer.

In various aspects of the invention, several different solvents are used to polymerize the polyamide, and/or to combine pre-polymerized polyamides with GO. Exemplary suitable solvents include but are not limited to water, n-methylpyrolidone (NMP), dimethylformamide (DMF), tetrahydrofuran (THF), alcohols, glycols such as ethylene glycol, propylene glycol and butylene glycol, as well as any other solvents suitable for polyamide synthesis. If the polyamides are pre-polymerized, they are typically pre-polymerized to a molecular weight that is more than about twice that of their monomeric form. In the final product that is generated by the methods described herein, the polymers e.g. polyamines, are generally polymerized to molecular weights in the range of from about 10,000 to about 140,000, e.g. about 10, 20, 30, 40, 50, 60, 70, 80, 90, 100, 110, 120, 130 or 140 kD.

The GO(m)/polyamide composite compositions described herein are used in a number of different applications. In fact, the compositions may be used for any application in which polyamide composites are used. In one exemplary embodiment, the composites are used to manufacture various conduits such as hoses, tubes, pipes, etc. The GO(m)/polyamide composites described herein are particularly useful, for example, in providing a reliable hose having: high flexibility; high pressure performance (for example, up to 200 atm); long seamless tube length (for example, 1 kilometer or longer); and tremendous durability (for example, to deal with corrosive chemicals).

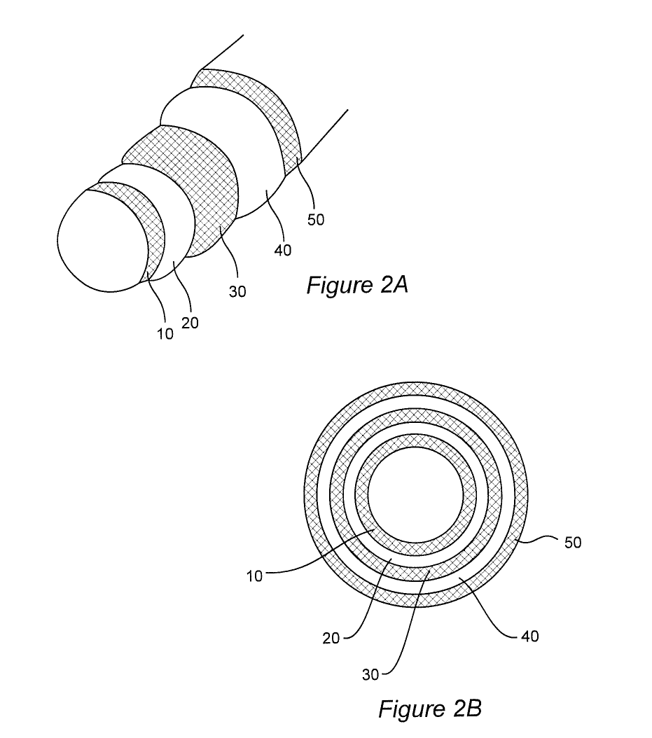

An exemplary hose that comprises a composite of the invention is depicted in FIGS. 2A and B. FIG. 2 A depicts a partial cut-away view of the wall of a flexible hose comprised of multiple layers, at least one of which may be formed from a composite of the invention. In FIG. 2A, metal layer 10 forms a flexible channel through which liquid flows. Metal layer 10 is typically formed from segmented, interlocking and/or coiled metal or alloy (e.g. steel) bands suitable for transporting a liquid of interest (e.g. a petroleum product). The direction of flow of the liquid is shown by the arrow in FIG. 2A. Layer 30 and layer 50 are also generally formed from a metal and may be either flexible or rigid, but at least one of layer 30 or layer 50 (or at least one of one or more metal layers outside layer 50, not shown) are typically rigid and form a protective casing or support for the hose. As can be seen, non-metal layers such as layer 20 and layer 40 are disposed between metal layers 10, 30, and 50. In some aspects of the invention, at least one of layer 20 and layer 40, typically layer 20, (or at least one of one or more additional non-metal layers positioned outside layer 50, not shown), is formed from a composite of the invention. Such composite layers are typically of a thickness of about 0.1 inches to about 0.8 inches.

During use, layer 10 can develop areas of corrosion through which petroleum product leaks. Upon a change in pressure (e.g. when the flow of liquid stops or slows, or when the hose is moved from a region of high pressure to low pressure, e.g. when moved from very deep water to or near the surface), metal layer 10 is subject to collapse as the leaked product vaporizes. By positioning a layer of composite of the invention (e.g. layer 20) on (outside) and in direct contact with layer 10, collapse is advantageously prevented or at least delayed due to the high durability and resistance to corrosion exhibited by the composites. Non-metal layer 20 also prevents corroding material from leaking from layer 10 and into the other layers of the hose, e.g. layers 30 and 40, etc. Thus, the use of composites as described herein in at least one non-metal layer of the hose wall, the non-metal layer intervening between two metal layers, extends the life of the hose. FIG. 2B is an end-on view of a cross-section of an exemplary hose wall (i.e. looking down the channel through which the liquid flows) such as that of FIG. 2A, also showing first layer 10, second layer 20, third layer 30, fourth layer 40 and fifth layer 50.

An exemplary application for such conduits is in the petroleum industry e.g. for the transport of crude oil, gasoline, and natural gas, for example, in flexible pipes for offshore crude oil transport and in automotive fuel lines. Substances transported in this industry often contain corrosive chemicals such as those that occur naturally in crude oil, and those that are used as additives (e.g. methanol, etc.). Further, the transport is frequently carried out at high temperatures ranging from e.g. 40 to 150° C., particularly when oil is pumped from a very deep well. Maintaining the integrity of conduits under these harsh conditions is essential for safety, environmental and economic reasons, and the use of the composites provided herein does so by increasing durability.

In additional exemplary aspects, the compositions are used in umbilicals, which is a term used to refer to connective systems between underwater equipment such as wellheads, subsea manifolds, or remote operated vehicles. An umbilical generally comprises a group of hydraulic lines, injection lines and/or electrical cables bundled together in a flexible arrangement, sheathed and sometimes armored for mechanical strength and/or a specific buoyancy.

In some embodiments, the composite compositions are extruded to form a desired product (e.g. via pipe extrusion), and may be e.g. from about 2-3 inches in diameter up to about 10 or more inches in diameter. However, a desired product can also be produced using other methods known in the art (e.g., injection molding). The composites may be formed into “stand-alone” products, e.g. hoses and/or other desired structures as described above, or they may be formed on the inside or outside of a substrate or scaffolding, thereby forming a coating on the substrate or scaffolding. The composites may be retained on or in the substrate (e.g. as a liner) or may be removed from the substrate (scaffolding, frame, etc.) after deposition, in which case they may retain the form attained during deposition.

The GO(m)/polyamide composite compositions can contain other additives, including but not limited to plasticizers, stabilizers, coloring agents, anti-oxidants, anti-fouling agents, UV stabilizers, antimicrobial agents, etc.

### EXAMPLES

The invention is now described with reference to the following examples. These examples are provided for the purpose of illustration only and the invention should in no way be construed as being limited to these examples but rather should be construed to encompass any and all variations which become evident as a result of the teaching provided herein.

### Example 1

### Exemplary Procedure for Synthesizing GO(m)/PA-11

Graphene oxide (GO(2)) and 11-Aminoundecanoic Acid monomer were carefully weighed to achieve the necessary GO loading (0.1 to 1.5 weight percent) in the ultimate GO(m)/PA-11 polymer. The GO(2) was then placed into a scintillation vial along with the 11-Aminoundecanoic Acid monomer. Approximately 40 milliliters of Millipore-filtered, de-ionized water was then added to the vial. The mixture was sonicated for one hour causing the exfoliation of the GO-(2) particles, and creating a homogenous dispersion. Then the dispersion was poured into a beaker lined with Teflon sheets. This beaker was placed into a vacuum oven that had a continuous in-flow of Argon throughout the ensuing polymerization. The out-flow valve was left open allowing the Argon gas and water vapor byproduct to escape. The oven was turned on and allowed to heat for a four hour period with an average temperature of about 232° C. The maximum that the temperature was allowed to reach was 246° C. After the four hour heating period, the oven was turned off and the Argon flow increased for faster cooling. After the temperature decreased below about 150° C., the out-flow valve was shut and the Argon turned off. The samples were then put onto a heat-press with Teflon sheets on both of the plate surfaces. Two Argon hoses blew Argon around the edges of the plates as the material was pressed. So as to not tear the Teflon sheets, the plates were allowed to heat up to about 200° C. before pressing. After pressing, the sample was taken out and allowed to cool with Argon still blowing around the edges of the Teflon sheets. Once cooled, the new film was then peeled off of the sheets, providing GO(m)/PA-11 composite.

### Example 2

### Water Diffusion into GO(m)/PA-11 Polymers

GO(m)/PA-11 polymers having various weight concentrations of GO(m) (0, 0.1, 1.0, and 1.5% by weight GO) were synthesized as described in Example 1. Samples of the polymers were obtained with a thickness of roughly 0.28 mm and an average face area of about 320 mm². Each sample was put into a desiccator for a period of at least one week before performing the weight gain test. Samples remained in the desiccators and were put in an 80° C. oven overnight, then put in a 100° C. oven for 1 hour. Each sample was taken out of the dessicator and immediately weighed. Each sample was then placed in a 20 mL scintillation vial filled to the brim with ˜20 mL of deionized water, then allowed to sit for a specified period of time. At the appropriate time, the water was poured out of the vial and the sample was removed by tapping the open vial against the researcher's gloved palm. The sample was buffed with a lint-free wipe until dry, then weighed using the same scale as for the previous measurement.

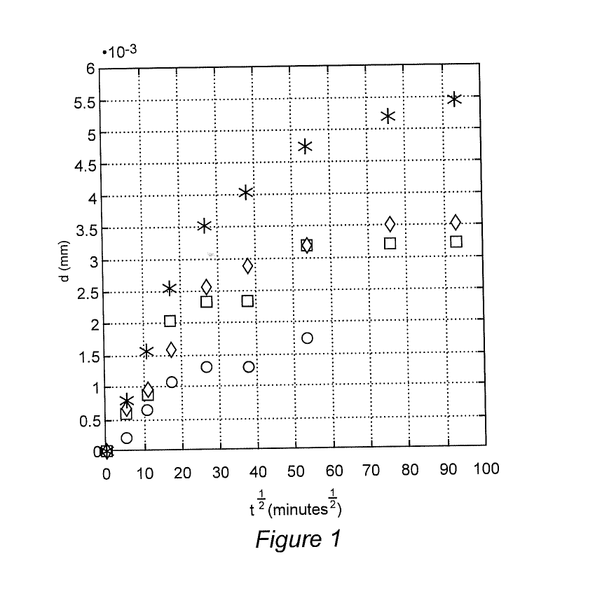

The amount of water absorbed by the sample as a percentage of the total weight of the sample is shown in Table 1 below. A graph of water diffusion as a function of time is plotted in FIG. 1 for each of the various weight concentrations of GO(m) in the GO(m)/PA-11 polymers (0.1%, 1% and 1.5%). The data showed that even a small amount of GO(m) (e.g. 0.1%) substantially decreases the water absorption of the GO(m)/PA-11 polymer.

TABLE 1

| | Diffusion (mm) · 10⁻³ | | | |
|---|---|---|---|---|
| Time^{1/2} | Neat PA-11 | | | |
| (minutes)^{1/2} | (average) | 0.1% GO | 1% GO | 1.5% GO |
| 0.00 | 0.00 | 0.00 | 0.00 | 0.00 |
| 5.48 | 0.78 | 0.58 | 0.64 | 0.22 |
| 10.95 | 1.55 | 0.87 | 0.96 | 0.65 |
| 17.32 | 2.55 | 2.04 | 1.60 | 1.08 |
| 26.83 | 3.52 | 2.33 | 2.56 | 1.30 |
| 37.95 | 4.04 | 2.33 | 2.88 | 1.30 |
| 53.67 | 4.75 | 3.20 | 3.20 | 1.73 |
| 75.89 | 5.20 | 3.20 | 3.52 | Nd |
| 92.95 | 5.44 | 3.20 | 3.52 | 1.95 |
| Modulus | 653 | | 998 | 980 |
| (MPa) | | | | |

### Example 3

### Reduction in the Rate of Degradation by Hydrolysis and Increase in the Equilibrium Weight Average Molecular Weight, Experiments A and B

Polyamide-11 was polymerized as described in Example 1 in the absence of oxygen and in the presence of GO at a weight fraction of 0.1% and 0.5% (Experiment A). The results for this aging experiment are reported in Table 2A. Another aging experiment (Experiment B) in which GO PA-11 samples were polymerized at GO loadings of 0.0%, 0.1% 0.5% 1.0% and 1.5%, was also conducted. The results of Experiment B are shown in Tables 2B and 2C,

In both aging experiments pieces of the polymerized material without any GO (neat PA-11) and pieces of the GO PA-11 at the varying weight per cents of GO in the PA-11 were placed in an oxygen free (anaerobic) deionized water to allow degradation by hydrolysis but not oxidation. Using high pressure glass aging tubes in both experiments, the neat PA-11 and the GO-PA-11 samples were aged in a temperature controlled oven at a temperature of 100° C. and at 120° C. Periodically, pieces of the neat and GO-containing PA-11 were removed and their weight average molecular weights were measured using Size Exclusion Chromatography (SEC) Multi Angle Laser Light Scattering (MALLS).

Table 2A reports the change in molecular weight versus time at 120° C. and at 100° C. for neat (unloaded) PA-11 and the GO-PA-11 materials at the varying weight per cents of GO polymerized in the PA-11. As can be seen, a surprising trend was observed. In experiment A, at both 100° C. and at 120° C., the Mw retention was significantly greater at 0.1% GO than in the neat sample. At the 0.5% loading there was no improvement. Without being bound by theory, this is likely the result of aggregation of the GO particles during this polymerization, and indicates that keeping the GO particles separated as individual nano-sheets is important for inhibiting water diffusion into the PA-11

In experiment B (Tables 2B and 2C), at both 100° C. and 120° C. there was again a significant improvement in retention of molecular weight at the loading of 0.1%, indicating a decrease in the rate of hydrolysis. Equally important, as in experiment A, an increase in the equilibrium molecular weight was observed at the longer times where the molecular weight is becoming constant. This equilibrium occurs when the rate of re-polymerization equals the rate of hydrolysis. Clearly, as the rate of hydrolysis decreases the equilibrium occurs at a higher value. The magnitude of the equilibrium molecular weight determines the safety margin for use of the PA-11 at a given temperature.

In experiment B, at both temperatures the molecular weight is retained significantly above the neat PA-11 at GO loadings of 0.5% GO as well as at 0.1%. At 1.0% the effect tapers off and at 1.5% there is no increase in the retention of the molecular weight. %. This data suggests that a range of low levels of loading, e.g. approaching about 0.05% but about 1.5% or less than 1.5%, are the most advantageous, e.g. from about 0.01 to 1.5% (such as 0.05 to 0.25%, 0.05 to 0.5%, 0.05 to 0.75%, 0.05 to 1.0%, 0.05 to 1.25%, 0.05 to 1.5%, 0.1 to 0.25%, 0.1 to 0.5%, 0.1 to 0.75%, 0.1 to 1.0% or 0.1 to 1.5%).

Reduction of GO to higher C:O ratios (e.g. above 3) increases the hydrophobicity of the PA-11 and, without being bound by theory, it appears that that reduction, along with the flat platelet shape of GO, is likely responsible for the decrease in loss of MW (i.e. in the decrease in degradation) observed at these low GO loadings.

TABLE 2A
Degradation in molecular weight (kDa) versus time (days)

| | | | |
|---|---|---|---|
| Day # | Unloaded | 0.1 wt % | 0.5 wt % |

Temperature: 120° C.

| | | | |
|---|---|---|---|
| 0 | 97 | 91 | 115 |
| 3 | 67 | 84 | Nd |
| 6 | 46 | 53 | 44 |
| 10 | 27 | 47 | 30 |
| 20 | 26 | 54 | 22 |
| 40 | 25 | 40 | 21 |
| 89 | 22 | 37 | 22 |
| 119 | 23 | 32 | 19 |

Temperature: 100° C.

| | | | |
|---|---|---|---|
| 0 | 230 | 80 | 106 |
| 5 | 61 | 68 | 51 |
| 15 | 52 | 75 | 44 |
| 35 | 45 | 64 | 26 |
| 83 | 30 | 31 | 20 |
| 195 | 23 | 32 | 22 |

TABLE 2B
Degradation at 120° C. in molecular weight (kDa) versus time (days); measured using multi-angle light scattering

| | Loading % (GO by weight) | | | | |
|---|---|---|---|---|---|
| | 0.0% | 0.1% | 0.5% | 1.0% | 1.5% |
| Day 0^{a} | 150,000 +/− 30,000 | 119,000 +/− 6,000 | 110,000 +/− 20,000 | 70,000 +/− 20,000 | 53,000 +/− 4,000 |
| Day 1 | 95,000 | 73,900 | 74,500 | 40,800 | 40,000 |
| Day 3 | 98,700 | 67,600 | 54,000 | 55,100 +/− 400^{b} | 44,800 |
| Day 10 | 40,500 | 69,000 +/− 7,000^{b} | 70,000 +/− 10,000^{b} | 60,000 | 41,000 |
| Day 19 | 45,300 | 57,000 | 69,400 | 41,800 | 34,500 |
| Day 28 | 37,000 +/− 1000^{b} | 46,000 +/− 9000^{b} | 53,700 +/− 800^{b} | 41,000 +/− 3000^{b} | 30,700 +/− 100^{b} |
| Day 55 | 22,600 | 34,000 | 40,600 | 29,400 | 27,700 |
| Day 83 | 30,800 | 40,000 | 44,000 +/− 6,000^{b} | 37,100 | 29,400 +/− 200^{b} |

^{a}The “Day 0” Mw was measured three times to test the accuracy of the instrument
^{b}Values are averages of multiple values because the first value measured did not fit the trend

TABLE 2C
Degradation at 100° C. in molecular weight (kDa) versus time (days)

| | Loading % (GO by weight) | | | | |
|---|---|---|---|---|---|
| | 0.0% | 0.1% | 0.5% | 1.0% | 1.5% |
| Day 0^{a} | 142,000 +/− 5,000 | 102,000 +/− 4,000 | 90,000 +/− 20,000 | 70,000 +/− 10,000 | 50,000 +/− 10,000 |
| Day 1 | 73,300 | 74,500 | 62,500 | 40,200 | 41,700 |
| Day 3 | 72,300 | 70,700 | 56,000 | 55,000 +/− 6000^{b} | 37,000 |
| Day 10 | 39,000 | 69,000 +/− 7,000^{b} | 66,000 +/− 5,000^{b} | 51,400 | 34,000 |
| Day 19 | 30,300 | 51,800 | 60,000 | 35,500 | 29,800 |
| Day 28 | 37,000 +/− 3000^{b} | 45,900 +/− 400^{b} | 50,000 +/− 2000^{b} | 37,000 +/− 3000^{b} | 24,000 +/− 2000^{b} |
| Day 55 | 22,200 | 33,600 | 39,500 | 26,700 | 26,700 |
| Day 83 | 25,000 | 36,300 | 36,000 +/− 5,000^{b} | 27,000 | 24,000 +/− 4,000^{b} |

^{a}The “Day 0” Mw was measured three times to test the accuracy of the instrument
^{b}Values are averages of multiple values because the first value measured did not fit the trend

### Example 4

### Effect of Percentage of GO-Loading on Mechanical Properties of GO-PA-11

This Example describes the testing of several important mechanical performance properties of GO-PA-11 with different levels of GO loading. Each GO-loaded sample was polymerized in parallel with a corresponding neat sample as described in Example 1.

The results in Table 3 show behavior similar to that which was observed in Example 3. First there is an increase in the modulus at a loading of 0.1% GO compared to the neat PA-11 which changes little within the precision up to a GO loading of 1.5%. The elasticity as measured by the % strain-elongation at break shows the surprising result that it is largest at a loading of 0.1% and then decreases. The maximum load the sample can hold also is at a maximum with a GO loading of 0.1% and then decreases.

In summary an important use for polyamides, particularly the long hydrocarbon chain polyamides PA-11 and PA-12, is their use in structures to transport and hold hydrocarbons. As water and water vapor are often present, the temperature at which they can be used is dependent on their resistance to hydrolytic degradation and the magnitude of the equilibrium molecular weight. Mechanical property retention is important but often mechanical properties are re-enforced by metal to withstand pressure. Hence the results of Example 3 are of primary importance.

TABLE 3

| | | | Maximum Tensile | |
|---|---|---|---|---|
| % GO | Strain (%) | Modulus (Mpa) | Stress (Mpa) | # of Samples |
| 0.0 | 420 +/− 50 | 800 +/− 100 | 208 +/− 60 | 9 |
| 0.1 | 480 +/− 40 | 1000 +/− 100 | 360 +/− 40 | 4 |
| 0.5 | 180 | 1100 +/− 300 | 140 +/− 50 | 5 |
| 1.0 | 130 +/− 20 | 1200 +/− 300 | 110 +/− 20 | 3 |
| 1.5 | 41 +/− 2.2 | 1200 +/− 200 | 70 +/− 20 | 2 |

### ADDITIONAL DEFINITIONS

Any ranges cited herein are inclusive unless stated otherwise.

The articles “a” and “an” are used herein to refer to one or to more than one (i.e. to at least one) of the grammatical object of the article. By way of example, “a sheet” means one sheet or more than one sheet, unless otherwise specified (e.g. when discussing the molecular structure of graphene below).

As used herein, “plurality” means at least two.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. Contemplated equivalents of the methods of treating anxiety related disorders disclosed here include administering fast acting compositions which otherwise correspond thereto, and which have the same general properties thereof, wherein one or more simple variations of substituents or components are made which do not adversely affect the characteristics of the methods and compositions of interest. The full scope of the invention should be determined by reference to the claims, along with their full scope of equivalents, and the specification, along with such variations.

We claim:

1. A polymer composition comprising a polyamide and graphene oxide, wherein said graphene oxide has a carbon to oxygen ratio of from 3 to 20.

2. The polymer composition of claim 1, wherein said polyamide is selected from the group consisting of PA-11 and PA-12.

3. The polymer composition of claim 1, wherein said graphene oxide is incorporated at a ratio of from 0.05% to 1.5% by weight of said polymer composition.

4. The polymer composition of claim 3, wherein said graphene oxide is incorporated at a ratio of from 0.05% to 0.5% by weight of said polymer composition.

5. An extruded article made from the composition of claim 1.

6. An injected molded article made from the composition of claim 1.

7. An extruded pipe comprising the composition of claim 1, wherein said graphene oxide is incorporated at a ratio of from 0.05% to 1.5% by weight of said polymer composition.

8. The extruded pipe of claim 7, wherein said polyamide is PA-11 or PA-12.

9. A method to inhibit hydrolysis in polyamide polymers comprising
incorporating graphene oxide into said polyamide polymers at a weight ratio of from 0.05% to 5.0% graphene oxide by weight, wherein said graphene oxide has a carbon to oxygen ratio of from 3 to 20.

10. The method of claim 9, wherein said polyamide is selected from the group consisting of PA-11 and PA-12.

11. The method of claim 9, wherein said graphene oxide is incorporated at a ratio of from 0.05% to 1.5% by weight of said polymer composition.

12. The method of claim 11, wherein said graphene oxide is incorporated at a ratio of from 0.05% to 0.5% by weight of said polymer composition.

13. A method to transport a hydrocarbon energy source comprising
pumping said hydrocarbon energy source through a flexible pipe material, wherein said flexible pipe material comprises a polymer composition comprising a polyamide and graphene oxide, wherein said graphene oxide has a carbon to oxygen ratio of from 3 to 20.

14. The method of claim 13, wherein said polyamide is selected from the group consisting of PA-11 and PA-12.

15. The method of claim 13, wherein said graphene oxide is incorporated at a ratio of from 0.05% to 5.0% by weight of said polymer composition.

16. The method of claim 13, wherein said graphene oxide is incorporated at a ratio of from 0.05% to 1.5% by weight of said polymer composition.
